(19) United States
(12) Patent Application Publication
(10) Pub. No.: US 2009/0245926 A1
(43) Pub. Date: Oct. 1, 2009

(54) Quick Connector for Portable Power Tools

(76) Inventor: Chung-Chih Wei, Taiping City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/410,530

(22) Filed: Mar. 25, 2009

(30) Foreign Application Priority Data
Mar. 28, 2008 (TW) 097205365

(51) Int. Cl. F16C 11/04

(52) U.S. Cl. 403/65

(57) ABSTRACT

A quick connector includes a connector body comprising longitudinal and lateral bores communicating each other; a male member adapted to secure to a coupling end of a portable power tool, and a stepped-diameter section rotatably secured to the connector body; and an L-shaped fitting having one end adapted to connect to a line for conveying pressurized fluid and the other end adapted to connect to the lateral bore. An outer surface of the other end of the L-shaped fitting comprises a retaining mechanism for securing the connection of the L-shaped fitting to the connector body and allowing a free turning of the L-shaped fitting about the connector body. The quick connector is adaptable.

### BACKGROUND OF THE INVENTION

1. Field of Invention

The invention relates to mechanical connectors and more particularly to an adaptable, universal joint type quick connector for a pneumatic system, a hydraulic system, or a portable power tool (e.g., pneumatic nail gun) with improved characteristics.

2. Description of Related Art

Conventionally, a portable (or handheld) power tool (e.g., pneumatic nail gun) is driven by compressed air fed from an air compressor via a line. It is often that a worker may connect the pneumatic nail gun to the line and disconnect the pneumatic nail gun from the line many times in a work day (i.e., frequent coupling and disengagement). Hence, a type of quick connector for achieving this purpose is commercially available. The quick connector is advantageous because it can establish a sealed and secured fluid line with a minimum amount of time and expense. The quick connector typically has a threaded male member adapted to secure to a coupling end of the pneumatic nail gun and a female member with internal threads adapted to secure to one end of the line leading to the air compressor.

However, the well known quick connector suffers from a couple of disadvantages. For example, the line may be bent greatly to block the normal fluid flow because a worker often needs to adjust or change positions during work. Moreover, the quick connector is applicable to a specific type of portable power tool because the male member of the quick connector is an integral part thereof and is thus not adapted to connect to the coupling end of a pneumatic nail gun of different specifications (i.e., having a different coupling end). This greatly limits the applications of the well known quick connector. Thus, the need for improvement still exists.

### SUMMARY OF THE INVENTION

It is therefore one object of the invention to provide an adaptable, universal joint type quick connector for a pneumatic system, a hydraulic system, or a portable power tool.

To achieve the above and other objects, the invention provides a quick connector comprising a connector body having a longitudinal bore and a lateral bore in communication therewith; a male member comprising means for fastening a coupling end of a portable power tool, and a stepped-diameter section above the fastening means, the stepped-diameter section comprising a first step having an outer diameter larger than an inner diameter of the longitudinal bore, a second step fitted in the longitudinal bore, a first annular groove between the first step and the second step and aligned with the lateral bore, an opening having end terminated at a bore of the male member and the other end terminated at the first annular groove, a third step passing the longitudinal bore and having an internally threaded member, a holed cap larger than an upper opening of the longitudinal bore so as to seat thereon, and a first threaded fastener adapted to drive through the cap to secure to the internally threaded member so as to assemble the cap and the male member together and allow a free turning of the connector body about both the first threaded fastener and the male member; and an L-shaped fitting having one end adapted to connect to a line for conveying pressurized fluid and the other end adapted to connect to the lateral bore of the connector body so as to communicate a bore of the L-shaped fitting with the bore of the male member wherein an outer surface of the other end of the L-shaped fitting comprises retaining means for securing the connection of the L-shaped fitting to the lateral bore of the connector body and allowing a free turning of the L-shaped fitting about the connector body.

The above and other objects, features and advantages of the invention will become apparent from the following detailed description taken with the accompanying drawings.

### BRIEF DESCRIPTION OF THE DRAWINGS

FIG. 1 is an exploded view of a first preferred embodiment of quick connector for portable power tools according to the invention;

FIG. 2 is a perspective view of the assembled quick connector;

FIG. 3 is a longitudinal sectional view of the quick connector of FIG. 2;

FIG. 4 is a longitudinal sectional view of a second preferred embodiment of quick connector for portable power tools according to the invention;

FIG. 5 is a perspective view showing a 360-degree turning of the L-shaped fitting about the connector body on a virtual vertical plane;

FIG. 6 is a perspective view showing a 360-degree turning of both the L-shaped fitting and the connector body about the male member on a virtual horizontal plane; and

FIG. 7 is a side elevation in part section showing the quick connector of either embodiment interconnecting a pneumatic nail gun and a line leading to an air compressor in use.

### DETAILED DESCRIPTION OF THE INVENTION

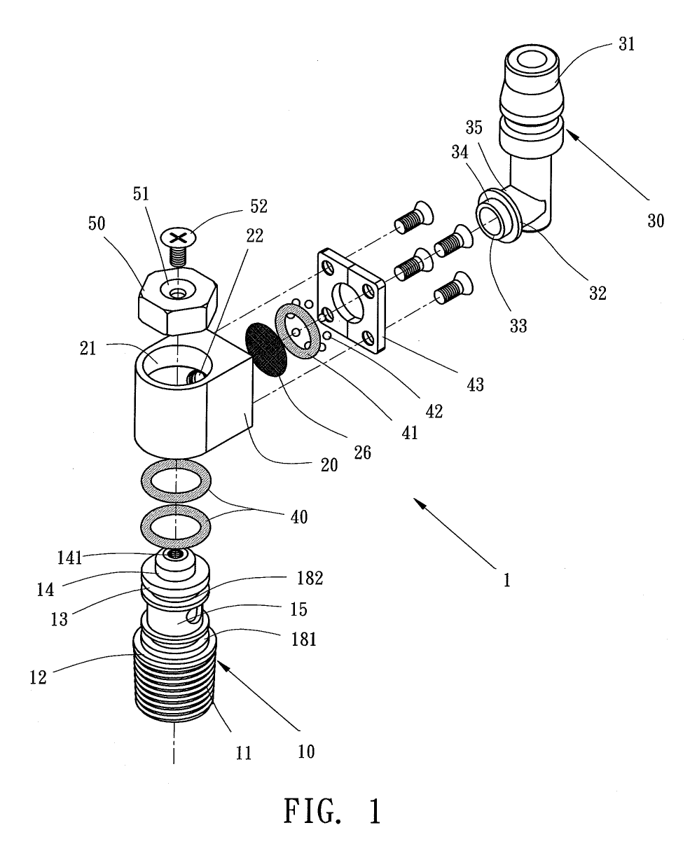

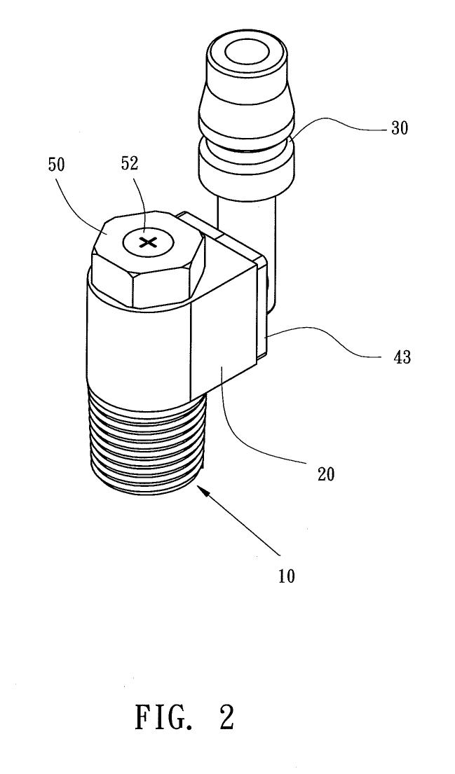

Referring to FIGS. 1 to 3, a quick connector 1 for portable power tools in accordance with a first preferred embodiment of the invention comprises the following components as discussed in detail below.

A cylindrical male member 10 comprises a threaded outer surface 11 adapted to secure to a coupling end of a pneumatic nail gun.

A connector body 20 comprises a longitudinal bore 21 and a lateral bore 22 in communication with the longitudinal bore 21 to form an inverted L-shaped passageway. Portion of the male member 10 above the threaded outer surface 11 is a stepped-diameter portion and comprises, from the top edge of the threaded outer surface 11, a first step 12 having an outer diameter larger than an inner diameter of the longitudinal bore 21, a second step 13 fitted in the longitudinal bore 21, and a third step 14 passing the longitudinal bore 21. An annular groove 15 is formed between the first step 12 and the second step 13 and is aligned with the lateral bore 22. An opening 17 has one end terminated at a bore 16 of the male member 10 and the other end terminated at the groove 15. An annular first trough 181 is formed immediately below the groove 15 and an annular second trough 182 is formed immediately above the groove 15 respectively. Two O-rings 40 are put on the first and second troughs 181, 182 respectively to establish a sealed coupling between the male member 10 and the connector body 20. The third step 14 has an internally threaded section 141. A hexagonal cap 50 has an axial hole 51 and a nut 52 adapted to drive through the hole 51 to threadedly secure to the internally threaded section 141 so as to assemble the cap 50 and the male member 10 together but allow a free turning of the connector body 20 about the nut 52. The size of the cap 50 is larger than the upper opening of the longitudinal bore 21 so as to seat thereon. The connector body 20 and the male member 10 are assembled in a liquid tight sealing relation. Further, the connector body 20 is adapted to turn about the male member 10 freely without the risk of disengagement.

An L-shaped fitting 30 has one end 31 adapted to connect to a line of a fluid system (e.g., an air compressor) and the other end 32 adapted to connect to the lateral bore 22 so that a bore 33 of the L-shaped fitting 30 may communicate with the bore 16 of the male member 10. The L-shaped fitting 30 at the outer surface of the other end 32 comprises a first annular portion 34 and a second annular portion 35 separated from the first annular portion 34 by an annular flange (not numbered). An O-ring 41 is put on the first annular portion 34 to establish a sealed coupling between the other end 32 of the L-shaped fitting 30 and the lateral bore 22 of the connector body 20. A plurality of steel balls 42 are positioned on the second annular portion 35 by the lateral bore 22 of the connector body 20 and a holed abutment plate 43 put on the other end 32 of the L-shaped fitting 30 and threadedly secured to the connector body 20. Hence, the L-shaped fitting 30 is retained by the holed abutment plate 43, the second annular portion 35, and the steel balls 42. Finally, a quick connector 1 according to the first preferred embodiment of the invention is assembled.

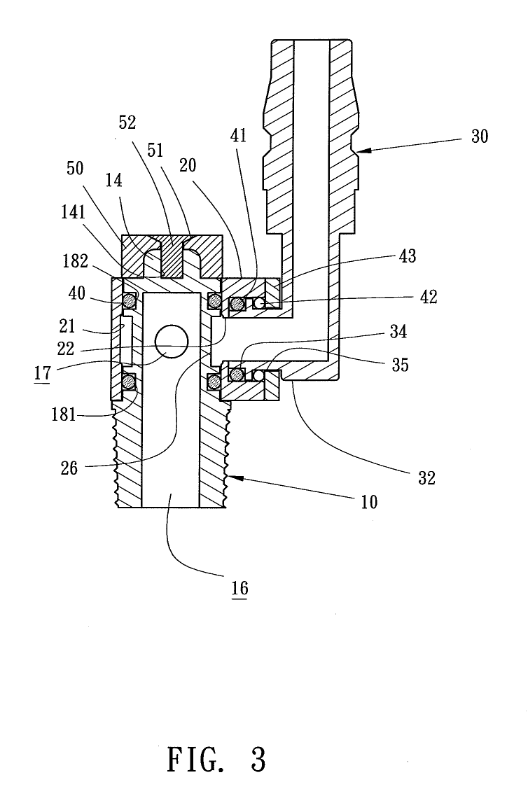

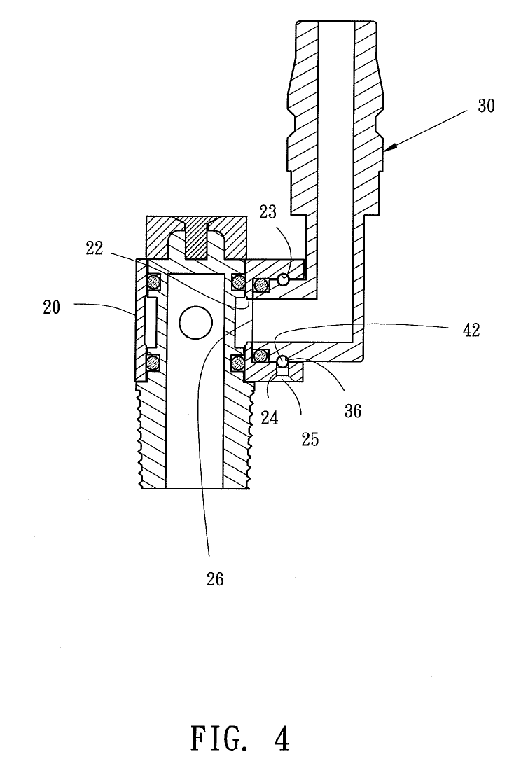

Referring to FIG. 4 in conjunction with FIG. 3, a second preferred embodiment of quick connector for portable power tools according to the invention is shown. The characteristics of the second preferred embodiment are detailed below. The second annular portion 35 and its adjacent annular flange of the first preferred embodiment are replaced by a first annular groove 36. A second annular groove 23, mated with the first annular groove 36, is formed on an inner surface of the lateral bore 22 of the connector body 20. A threaded hole 24 is formed on the connector body 20 to communicate the second annular groove 23 with the external. After attaching the L-shaped fitting 30 to the connector body 20, a plurality of steel balls 42 are inserted into an annular space defined by the mated first and second annular groove 36, 23 through the threaded hole 24. Finally, a nut 25 is driven into the threaded hole 24 to retain the steel balls 42. The L-shaped fitting 30 is thus adapted to turn about the connector body 20 freely without the risk of disengagement due to the provision of the steel balls 42.

Referring to FIGS. 1, 3 and 4 again, a filter 26 is provided in the lateral bore 22 of the connector body 20 and is fastened between the mouth of the other end 32 of the L-shaped fitting 30 and an internal shoulder of the lateral bore 22 of the connector body 20. The filter 26 is adapted to strain coarse particles from compressed air supplied from an air compressor. The provision of the filter 26 can prolong the useful life of both the quick connector 1 and a pneumatic nail gun attached thereto in use.

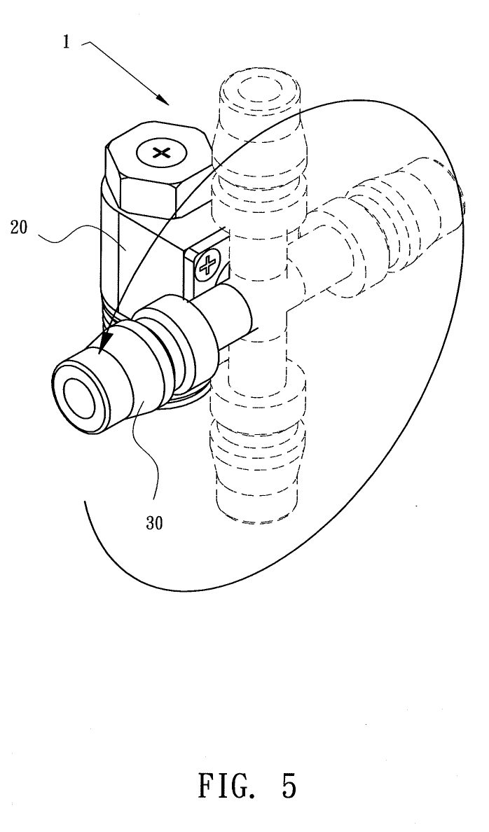

Referring to FIG. 5 in conjunction with FIG. 1, a 360-degree turning of the L-shaped fitting 30 about the connector body 20 on a virtual vertical plane is shown. This turning is made possible because, as stated above, the steel balls 42 are retained between the other end 32 of the L-shaped fitting 30 and the lateral bore 22 of the connector body 20.

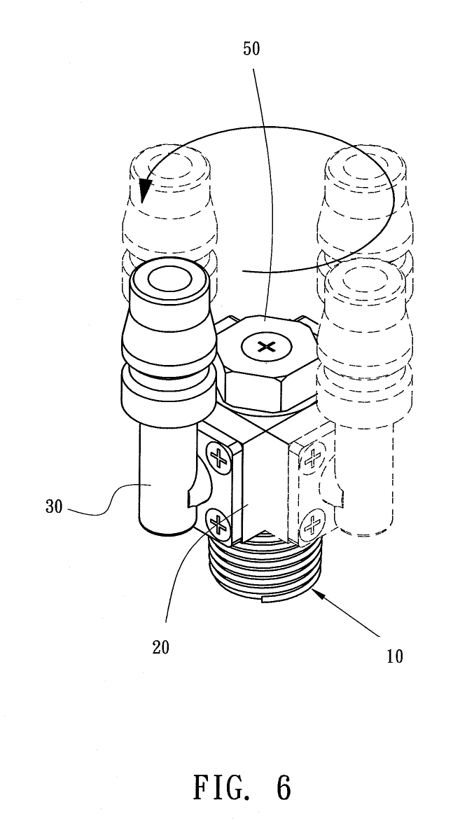

Referring to FIG. 6 in conjunction with FIG. 1, a 360-degree turning of both the L-shaped fitting 30 and the connector body 20 about the male member 10 on a virtual horizontal plane is shown in which the male member 10 is attached to a coupling end of a pneumatic nail gun. This turning is made possible because, as stated above, the connector body 20 is adapted to turn about the nut 52.

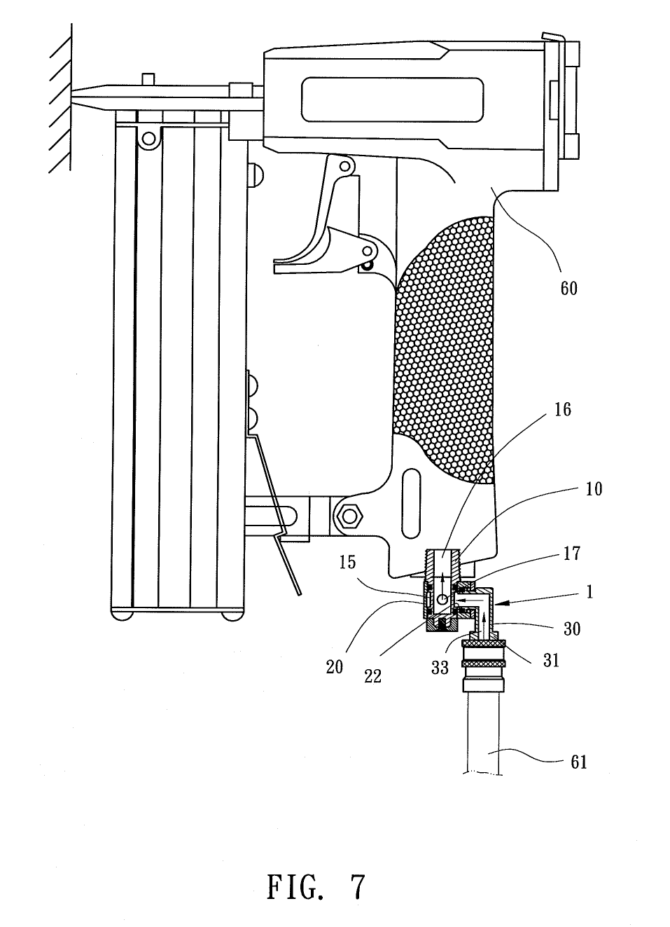

Referring to FIG. 7, the quick connector 1 of either embodiment in a use position is shown. The male member 10 is connected to a coupling end of a pneumatic nail gun 60 and one end 31 of the L-shaped fitting 30 is connected to a line 61 leading to an air compressor (not shown). Compressed air from the air compressor passes the bore 33 of the L-shaped fitting 30 to feed into the pneumatic nail gun 60 via the lateral bore 22, the annular groove 15, the opening 17, and the bore 16 of the male member 10 for driving the pneumatic nail gun 60.

While the quick connector is described with respect to a pneumatic power tool as preferred embodiments of the invention, it is understood that the quick connector may equally operate with respect to a hydraulic power tool without departing from the scope of the invention.

It is contemplated by the invention that the quick connector may operate in a manner similar to a universal joint without worrying the line 61 being bent to block fluid flow in use. That is, a user may use the quick connector to interconnect a pneumatic nail gun and a line leading to an air compressor. Next, the user may activate the air compressor to supply compressed air to the pneumatic nail gun via the quick connector. The user may easily change or adjust his or her working position by freely turning the quick connector in a manner described above without worrying an undesired disengagement of the quick connector from the pneumatic nail gun or a fluid blocking in the line. Moreover, a user may change the male member and the cap and its accessories to ones of different specifications in order to connect the quick connector to a coupling end of a pneumatic nail gun different from one used before. That is, the quick connector is highly adaptable.

While the invention herein disclosed has been described by means of specific embodiments, numerous modifications and variations could be made thereto by those skilled in the art without departing from the scope and spirit of the invention set forth in the claims.

What is claimed is:

1. A quick connector comprising:
a connector body comprising a longitudinal bore and a lateral bore in communication therewith;
a male member comprising means for fastening a coupling end of a portable power tool, and a stepped-diameter section above the fastening means, the stepped-diameter section comprising a first step having an outer diameter larger than an inner diameter of the longitudinal bore, a second step fitted in the longitudinal bore, a first annular groove between the first step and the second step and aligned with the lateral bore, an opening having end terminated at a bore of the male member and the other end terminated at the first annular groove, a third step passing the longitudinal bore and having an internally threaded member, a holed cap larger than an upper opening of the longitudinal bore so as to seat thereon, and a first threaded fastener adapted to drive through the cap to secure to the internally threaded member so as to assemble the cap and the male member together and allow a free turning of the connector body about both the first threaded fastener and the male member; and
an L-shaped fitting having one end adapted to connect to a line for conveying pressurized fluid and the other end adapted to connect to the lateral bore of the connector body so as to communicate a bore of the L-shaped fitting with the bore of the male member wherein an outer surface of the other end of the L-shaped fitting comprises retaining means for securing the connection of the L-shaped fitting to the lateral bore of the connector body and allowing a free turning of the L-shaped fitting about the connector body.

2. The quick connector of claim 1, wherein the retaining means comprises at least one first annular portion on the outer surface of the other end of the L-shaped fitting, at least one first O-ring put on the at least one first annular portion, a second annular portion on the outer surface of the other end of the L-shaped fitting, a plurality of steel balls positioned on the second annular portion, and a holed abutment plate put on the other end of the L-shaped fitting and secured to the connector body for securing the connection of the L-shaped fitting to the lateral bore of the connector body and retaining the steel balls.

3. The quick connector of claim 1, wherein the retaining means comprises a second annular groove on the outer surface of the other end of the L-shaped fitting, a mated third annular groove on the lateral bore of the connector body, a threaded hole on the connector body to communicate with the second annular groove, a plurality of steel balls inserted into an annular space defined by the mated second and third annular groove through the threaded hole after attaching the other end of the L-shaped fitting to the lateral bore of the connector body, and a second threaded fastener driven into the threaded hole to secure the connection of the L-shaped fitting to the lateral bore of the connector body and retain the steel balls.

4. The quick connector of claim 1, further comprising a filter disposed in the lateral bore of the connector body and fastened between the other end of the L-shaped fitting and the lateral bore of the connector body.

5. The quick connector of claim 1, wherein the fastening means of the male member is a threaded outer surface and the coupling end of the portable power tool has internal threads adapted to secure to the threaded outer surface of the male member.

6. The quick connector of claim 1, further comprising an annular first trough formed below the first annular groove, an annular second trough formed above the first annular groove, and two second O-rings put on the first and second troughs respectively.
